(19) United States
(12) Patent Application Publication
(10) Pub. No.: US 2020/0163285 A1
(43) Pub. Date: May 28, 2020

(54) SUSTAINABLE TANDEM VERTICAL FARMING SYSTEM FOR URBAN SHOPPING CENTERS

(71) Applicant: ENVIRONMENT & ENERGY TECHNOLOGY, Daejeon (KR)

(72) Inventor: Suk Ku SIM, Daejeon (KR)

(73) Assignee: ENVIRONMENT & ENERGY TECHNOLOGY, Daejeon (KR)

(21) Appl. No.: 16/062,826

(22) PCT Filed: Dec. 14, 2016
(86) PCT No.: PCT/KR2016/014618

§ 371 Date: Jun. 15, 2018

(30) Foreign Application Priority Data
Dec. 17, 2015 (KR) 10-2015-0180727

(51) Int. Cl. A01G 9/24; A01G 31/06

(52) U.S. Cl. CPC A01G 9/24; A01G 7/045; A01G 31/06

(57) ABSTRACT

The present disclosure relates to an urban vertical farming system linked directly to a shop. The urban vertical farming system comprises a shop space communicating with a crop cultivation space through a door, and comprises an environment control unit for controlling the environment of the cultivation space, a vertically-movable rack for placing crops cultivated in the cultivation space, a rack transportation means for moving the vertically-movable rack vertically up and down through an area communicating between the cultivation space and the shop space, a pipe system for circulating and controlling the air containing much oxygen and much carbon dioxide in the vegetable cultivation rooms and the mushroom cultivation rooms, respectively, of the cultivation space, and a sustainable recycling means for organic fertilizers manufactured with crops residues from the vegetable cultivation rooms and the mushroom cultivation rooms of the cultivation space and substrate waste after mushroom cultivation.

### TECHNICAL FIELD

The present disclosure relates to an urban vertical farming technology for urban shopping centers, and more particularly to an urban vertical farming system for urban shopping centers by transporting crops cultivated in a cultivation space in a controlled environment vertically to a shop on a lower or higher floor to sell them directly to consumers without an additional harvesting and transportation process from farms.

### BACKGROUND

Typically, a vertical farm in urban areas, that is, urban vertical farm, refers to a facility called a plant factory for continuously producing crops regardless of seasons or locations by artificially controlling light, temperature, humidity, concentrations of oxygen or carbon dioxide, ventilation, liquid for cultivation or substrates in a controlled facility. People are especially interested in such urban vertical farms in urban areas of high population densities because fresh crops can be obtained regardless of seasons and locations, and mass production is enabled in small spaces in buildings without the need of additional farmland.

Specifically, the cultivation space in an urban vertical farm is structured to install crop racks with one or multiple shelves depending on crop height, and arrange crop cultivation trays on the shelves of the racks. Although the environment including light, temperature, humidity and ventilation or gas concentrations in the cultivation space is automatically controlled, the increasing cost of using automatic controllers and the increase in real estate prices for urban buildings are a factor reducing the efficiency and economy of urban vertical farms. For that reason, there is a great need of strategies for enhancing the efficiency of urban vertical farms.

Moreover, although urban vertical farms artificially and automatically control the cultivation environment, it is required manually to arrange crop cultivation trays on the racks to start crop cultivation, harvest the crop, and transport the crop cultivation trays on the shelves after harvesting the crop. Therefore, a suggestion has been made to change the conventional manual process to an automatic process to save the labor cost and increase productivity.

For example, Korea Patent Registration No. 10-1571548 published on Nov. 24, 2015 discloses the “Plant Factory Automation System” arranged across the center of a cultivation space, capable of moving upward and downward to go to each floor and conducting automated seedling planting and crop harvesting in a plant factory with a cultivation space having multiple racks.

The plant factory automation system disclosed in the aforementioned registered patent includes a plurality of cages in which cultivated crops are planted; the solid substrates are transported to each cage by means of a conveyer; a robot plants seedlings or harvests cultivated crops; and the harvested crops are transported from the cages to a packing site by means of a conveyer.

By the way, the aforementioned plant factory automation system requires connections of the cages fixed in the cultivation space to the packing site outside the cultivation space by using a plurality of conveyers, and the configuration is thus complex and more operation costs can be required because a robot capable of conducting the planting and harvesting process that should be carefully conducted is required.

Therefore, there is still a need of technology for increasing the efficiency of urban vertical farms.

### PRIOR-ART DOCUMENT

Korea Patent Registration No. 10-1571548 published on Nov. 24, 2015.

### SUMMARY

### Technical Problem

Therefore, the present disclosure provides an urban vertical farming system linked to a shop for eliminating the process of harvesting and transporting cultivated crops to allow consumers to harvest and buy the crops fully grown in order to address the aforementioned problems of prior art and increase the efficiency of the urban vertical farming system.

Specifically, the present disclosure provides an urban vertical farming system linked to a shop to allow consumers to harvest and package crops as much as they want directly from crop trays displayed on vertically-movable racks to buy them by providing the vertically-movable racks moving between the cultivation space of an urban vertical farm and a shop to allow consumers to harvest and buy the crops. This aims to eliminate the process of harvesting and transporting cultivated crops to enable consumers to harvest and buy the crops fully grown.

Furthermore, the present disclosure provides an urban vertical farming system linked directly to a shop for crushing cultivated crop residues from the urban vertical farm or urban food waste to manufacture a substrate; putting and sterilizing the manufactured substrate in cultivation trays to inoculate the substrate with salt-tolerant edible mushroom spores to cultivate and grow the edible mushrooms in a controlled environment; transporting the cultivation trays with the fully grown edible mushrooms to the shop by means of the vertically-movable racks; and then allowing consumers themselves to harvest and buy them.

Furthermore, the present disclosure provides an urban vertical farming system with a configuration divided into vegetable cultivation rooms for photosynthesis having glass exterior walls transmitting sunlight through the cultivation space of the urban vertical farm and internal mushroom cultivation rooms not requiring sunlight for photosynthesis, and for efficient operation of the cultivation space of the vertical farm by circulating the air between the vegetable cultivation rooms and the mushroom cultivation rooms.

It should be noted that specific description about known technology related to the present disclosure is omitted if it may unnecessarily obscure the gist of the present disclosure while describing the present disclosure.

### Technical Solution

An aspect of the present disclosure for solving the aforementioned prior art problems is to provide an urban vertical farming system linked directly to a shop in a building, comprising a crop cultivation space formed in the building, an environment control unit for controlling the environment of the cultivation space, a shop space placed close to the cultivation space in the vertical direction, a vertically-movable rack for placing crops, and a rack transportation means for moving the vertically-movable rack vertically up and down through an area communicating between the cultivation space and the shop space.

Another aspect of the present disclosure is to provide an urban vertical farming system linked directly to a shop, in which exemplary crops cultivated in the cultivation space can include salt-tolerant edible mushrooms grown from spores inoculated into a substrate manufactured by recycling crop residues from the cultivation space or urban food waste. For this purpose, the cultivation space can include an incubation room for incubating spores of the salt-tolerant edible mushrooms for germination after inoculation, and a growing room for growing them to be a marketable size after germination; and the environment control unit can include an incubation room environment control unit for controlling the environment of the incubation room, and a growing room environment control unit for controlling the environment of the growing room.

Another aspect of the present disclosure is to provide an urban vertical farming system linked directly to a shop, in which the cultivation space can include vegetable cultivation rooms for green plants growing through photosynthesis requiring sunlight and mushroom cultivation rooms for cultivating salt-tolerant edible mushrooms of which the spores are inoculated into a substrate manufactured by recycling crop residues from the cultivation space or urban food waste; the vegetable cultivation rooms can be positioned on the internal side of an external glass wall of the building; and the mushroom cultivation rooms can be on the internal side of the vegetable cultivation rooms.

For this purpose, the system can comprise a pipe system for circulating the air containing much oxygen in the vegetable cultivation rooms into the air containing much carbon dioxide in the mushroom cultivation rooms and vice versa. With respect to this, the vegetable cultivation rooms can be kept at the atmospheric pressure, and the mushroom cultivation rooms at an air pressure higher than the atmospheric pressure; the pipe system can include a first pipe system for natural ventilation of the air in the mushroom cultivation rooms into the vegetable cultivation rooms by means of an atmospheric pressure difference, and a second pipe system for forced ventilation of the air in the vegetable cultivation rooms into the mushroom cultivation rooms.

Moreover, the environment control unit can use measured carbon dioxide concentrations or oxygen concentrations in the vegetable cultivation rooms and the mushroom cultivation rooms to control operation of the pipe system.

### Advantageous Effects

In view of the above, the present disclosure can eliminate the process of harvesting and transporting crops cultivated in the urban vertical farm, and enables the crops fully grown to be transported from the urban vertical farm on a higher floor directly to a shop on a lower floor for consumers to harvest and buy them. As a result, since the process of harvesting and packaging the crops cultivated in the urban vertical farm and then transporting them can be eliminated, the efficiency of the urban vertical farms can be significantly increased.

Specifically, the present disclosure provides a vertically-movable rack moving vertically between the cultivation space and the shop to enable consumers to harvest crops directly from the cultivation trays and buy the harvested crops from the urban vertical farm, so that consumers can harvest the crops from the crop cultivation trays displayed on the vertically-movable racks transported from the cultivation space of the urban vertical farm to the shop, package the crops, and buy the crops as much as they want.

Therefore, this is a novel display technique to attract consumers since consumers can selectively buy fresh crops and enjoy harvesting crops directly from cultivation trays, and shop owners can provide fresher crops to consumers and use vertically-movable racks coming down from the ceiling or up from the bottom without the need of using separate stalls.

Furthermore, the substrate used in the present disclosure is manufactured by crushing cultivated crop residues from the vertical farm and urban food waste; the manufactured substrate is placed in the cultivation trays for sterilization and then inoculated with salt-tolerant edible mushroom spores to cultivate and grow edible mushrooms in a controlled environment; the cultivation trays with fully grown edible mushrooms are transported to a shop by means of the vertically-movable racks; and consumers themselves can harvest and buy them.

Therefore, food waste can be recycled effectively, and consumers can be provided with fresh edible mushrooms and buy edible mushroom they harvest for themselves.

Moreover, the present disclosure can provide a sustainable vertical farming system in which crop residues from cultivating and harvesting the crops are used as a mushroom cultivation substrate to cultivate the mushrooms, and substrate biomass waste that remains after cultivating the mushrooms supplies organic fertilizers required in crop cultivation to continue to give and take recycled materials.

Furthermore, the present disclosure provides an urban vertical farming system with a configuration divided into vegetable cultivation rooms having glass exterior walls to transmit sunlight through the cultivation space of the urban vertical farm and internal mushroom cultivation rooms not requiring sunlight, and for efficiently operation of the vertical farm by circulating the air between the vegetable cultivation rooms and the mushroom cultivation rooms to provide oxygen emitted in vegetable growth to the mushrooms to grow, and use carbon dioxide emitted in mushroom growth to the vegetables to grow.

### BRIEF DESCRIPTION OF THE DRAWINGS

FIG. 1 is a schematic view illustrating the configuration of an exemplary vertically-movable rack in a cultivation space of an urban vertical farming system linked directly to a shop in accordance with an embodiment of the present disclosure;

FIG. 2 is a schematic view illustrating movement of the vertically-movable rack between the cultivation space and a shop for the urban vertical farming system linked directly to the shop in accordance with an embodiment of the present disclosure;

FIG. 3 is a schematic view illustrating a display of the vertically-movable rack in a shop for the urban vertical farming system linked directly to a shop in accordance with an embodiment of the present disclosure;

FIG. 4 is a schematic view illustrating another configuration of the vertically-movable rack in the cultivation space of the urban vertical farming system linked directly to a shop in accordance with an embodiment of the present disclosure;

FIG. 5 is a schematic view illustrating a display of the vertically-movable racks in a shop of the urban vertical farming system linked directly to the shop in accordance with an embodiment of the present disclosure;

FIG. 6 is a photograph illustrating a process of edible mushroom change in a cultivation bottle in which the edible mushrooms are cultivated in the urban vertical farming system linked directly to a shop in accordance with an embodiment of the present disclosure;

FIG. 7 is a photograph illustrating the state of edible mushrooms grown in cultivation trays in the urban vertical farming system linked directly to a shop in accordance with an embodiment of the present disclosure;

FIG. 8 is a flow illustrating a process of manufacturing a substrate for salt-tolerant edible mushrooms cultivated in the urban vertical farming system linked directly to a shop in accordance with an embodiment of the present disclosure; and

FIG. 9 is a schematic view illustrating the arrangement of cultivation space of the urban vertical farming system linked directly to a shop in accordance with an embodiment of the present disclosure.

### DETAILED DESCRIPTION

The specific embodiments of the present disclosure will now be described in detail with reference to the accompanying drawings. It should be noted that the following description and drawings are intended to help readers to understand the present disclosure readily, but not intended to limit the scope of technical idea of the present disclosure. That is, since the embodiments described below can be varied in many ways while implemented in the field, and those variations belong to the present disclosure where they are deemed to be within the technical idea of the present disclosure, those skilled in the art will understand the technical idea of the present disclosure readily through the following description.

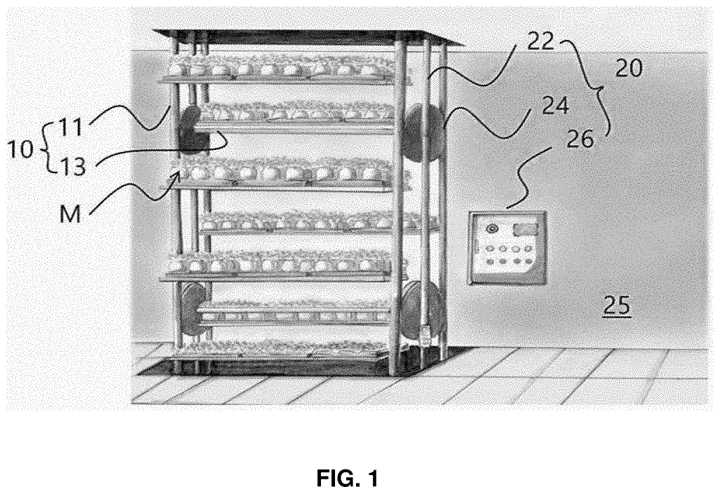

FIG. 1 is a schematic view illustrating the configuration of an exemplary vertically-movable rack in a cultivation space of the urban vertical farming system linked directly to a shop in accordance with an embodiment of the present disclosure.

Referring to FIG. 1, the vertically-movable rack 10 is installed on the floor of a cultivation space 25 of an urban vertical farm. The vertically-movable rack 10 includes a rack frame 11 and horizontal shelves 13. The rack frame 11 is a support frame supporting the right and left corners of the generally-hexahedron vertically-movable rack 10. The horizontal shelves 13 are installed horizontally between the right and left rack frames 11 in a multiple-layer structure.

The distance between neighboring higher and lower horizontal shelves 13 can be determined to correspond to the height of fully-grown crops M. In a preferred embodiment in accordance with the present disclosure, the crops M can be salt-tolerant edible mushrooms, for example, oyster mushrooms, and the distance can be at intervals of about 30 cm. In the illustrated example, there are six layers of horizontal shelves 13, and it will be apparent to those skilled in the art that this is just an example.

The vertically-movable rack 10 can be installed in a predetermined location of the cultivation space 25 and move up and down by means of a rack transportation means 20. The rack transportation means 20 includes a vertical fixing frame 22, a rotatable roller 24 and a transportation control unit 26.

The vertical fixing frame 22 is fixed in a vertical bar type to be parallel with the rack frame 11 of the vertically-movable rack 10. The center of the rotatable roller 24 is fixed to the vertical fixing frame 22, and the external surface thereof contacts the rack frame 11 of the vertically-movable rack 10.

The rotatable roller 24 rotates by means of a driving means, for example, rotatable motor not shown, to allow the rack frame 11 to move up and down in relation to the position of the rotatable roller 24. The plane of the rack frame 11 contacting the external surface of the rotatable roller 24 can be engaged each other in a sawtooth structure not to slip while the rotatable roller 24 is not in operation.

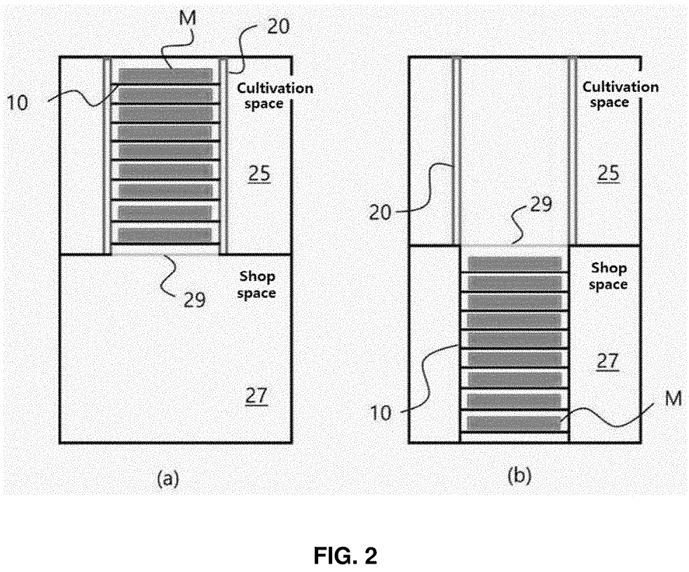

The transportation control unit 26 controls vertical movement of the vertically-movable rack 10 by controlling the rotation of the rotatable roller 24 and the operation of a door 29 (see FIG. 2) conducted manually by workers. The door 29 (see FIG. 2) can be controlled to be normally closed but open when the vertically-movable rack 10 starts to move.

It will be apparent to those skilled in the art that the configuration of the aforementioned rack transportation means 20 is not limited to the illustrated example, and other alternative various configurations can be implemented, which can move up and down the vertically-movable rack 10 in the vertical direction.

As described above, in the urban vertical farming system linked directly to a shop, the cultivation space of which the environment is controlled is close to and communicates with the shop for selling harvested crops to consumers, and crops M displayed in the vertically-movable rack 10 can be transported vertically from the cultivation space to the shop.

Workers in the urban vertical farm can determine how many crops M to be placed in the vertically-movable rack 10 and place them therein in consideration of the number of crops sold in the shop. After selecting marketable crops M from the crops cultivated in the cultivation space and placing them in the vertically-movable rack 10, the workers can press a button provided in the transportation control unit 26 to move the vertically-movable rack 10 to the shop.

Moreover, consumers are encouraged to put the mushroom cultivation trays left after they harvest and buy the mushrooms back in the vertically-movable rack 10, so that they can go to the cultivation space 25 when the vertically-movable rack 10 moves vertically back to the cultivation space 25. The workers in the cultivation space 25 can take out the substrate waste from the cultivation trays to recycle the tray and substrate waste as an organic fertilizer required for crop cultivation.

FIG. 2 is a schematic view illustrating movement of the vertically-movable rack between the cultivation space and a shop for the vertical farming system linked directly to a shop in accordance with an embodiment of the present disclosure.

Referring to FIG. 2, it shows an example of placing a shop space 27 under the cultivation space 25. On the contrary, the shop space 27 can also be placed above the cultivation space 25. FIG. 2a shows the vertically-movable rack 10 positioned in the cultivation space 25, and FIG. 2b shows the vertically-movable rack 10 positioned in the shop space 27. As shown in FIG. 2b, the vertically-movable rack 10 can function as a stall to display the crops M to be sold.

In the example shown, the cultivation space 25 communicates with the shop space 27 through a door 29. That is, while the vertically-movable rack 10 does not move, the door 29 is normally kept closed. Meanwhile, while the vertically-movable rack 10 moves, the door 29 can be open when workers control the rack transportation means 20.

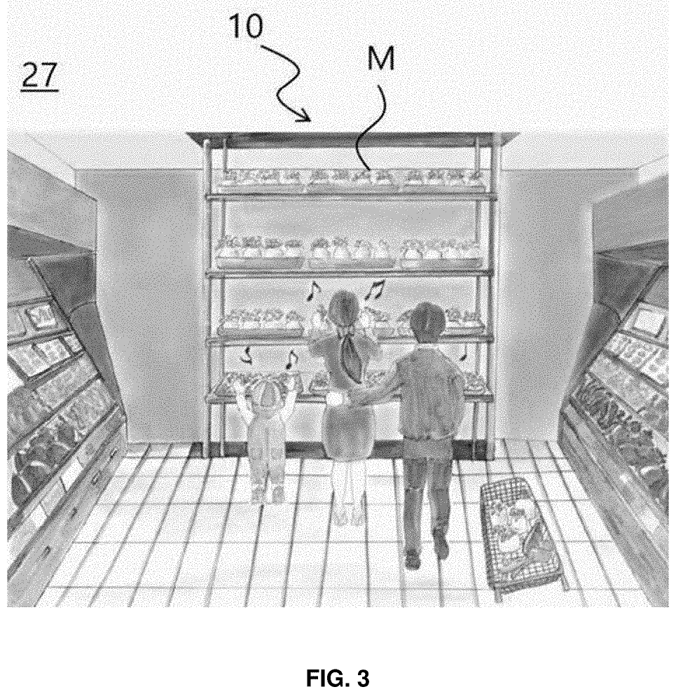

FIG. 3 is a schematic view illustrating a display of the vertically-movable rack in a shop for the urban vertical farming system in accordance with an embodiment of the present disclosure.

Referring to FIG. 3, the vertically-movable rack 10 is shown after moving from the cultivation space of the urban vertical farm to the shop space 27. The vertically-movable rack 10 can function as a stall or display cabinet to sell the crops M. The crops M displayed in the vertically-movable rack 10 are displayed while planted in the cultivation trays used in cultivation in the cultivation space. For buying the crops M, consumers can harvest and put the crops M as much as they want in, for example, plastic bags from the cultivation trays to attach a price tag. The consumers put the cultivation trays remaining after harvesting the crops M back in the rack 10 to be transported back to the cultivation space.

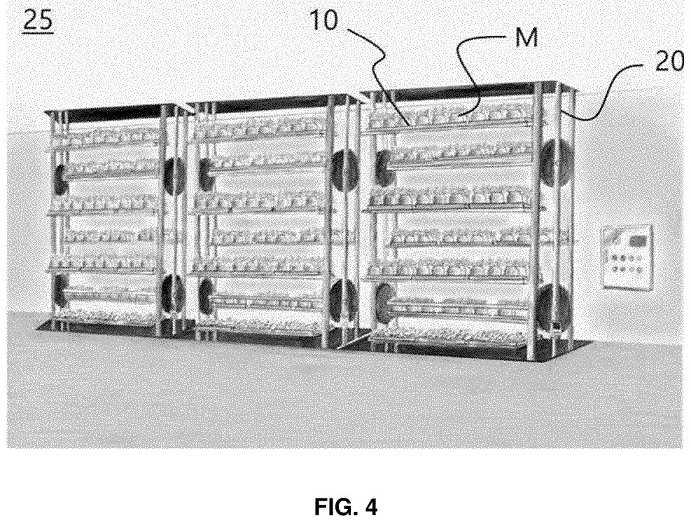

FIG. 4 is a schematic view illustrating another configuration of the vertically-movable rack in the cultivation space of the urban vertical farming system linked directly to a shop in accordance with an embodiment of the present disclosure. Referring to FIG. 4, it is an example that three vertically-movable racks 10 are positioned in comparison with FIG. 1 in which one vertically-movable rack 10 is positioned. As described above, the number of installed vertically-movable racks 10 can be varied depending on shop scales or sales policies.

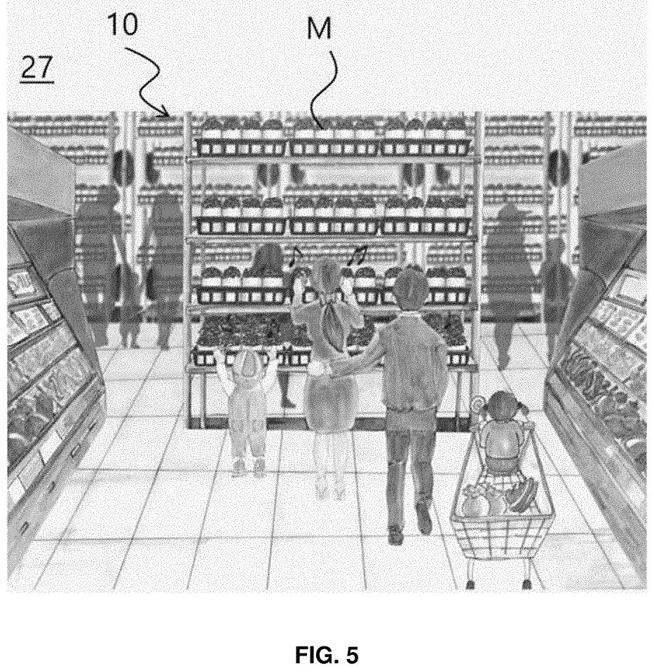

FIG. 5 is a schematic view illustrating a display of the vertically-movable racks in a shop of the urban vertical farming system linked directly to the shop in accordance with an embodiment of the present disclosure.

Referring to FIG. 5, a plurality of vertically-movable racks 10 are positioned on the wall side in the shop space 27, and one vertically-movable rack 10 is positioned in the center of the shop. The position of respective vertically-movable racks 10 is not limited to those described above and can be determined in various ways depending on shop operation plans.

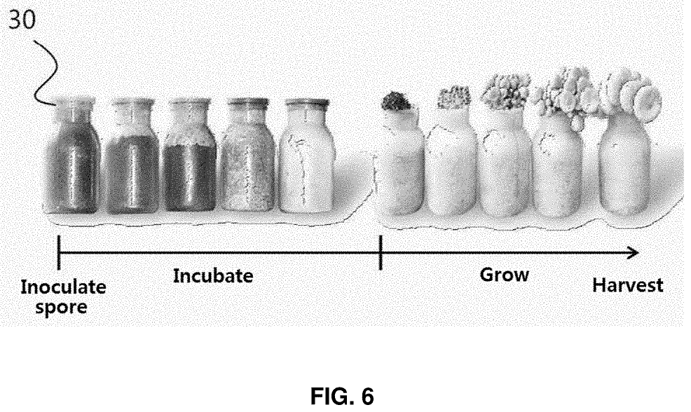

FIG. 6 is a photograph illustrating a process of edible mushroom change in a cultivation bottle in which the edible mushrooms are cultivated in the urban vertical farming system in accordance with an embodiment of the present disclosure.

Referring to FIG. 6, the growing process is shown from inoculating a substrate with oyster mushroom spores to harvesting oyster mushrooms which are an exemplary salt-tolerant edible mushroom as a preferred example of the crops M cultivated in the urban vertical farming system in accordance with the present disclosure. The oyster mushrooms are planted in cultivation tray 30 in clear plastic bottle shape. The substrate in the cultivation tray 30 can be manufactured by particularly using food waste for growing the oyster mushrooms.

The environment for the mushroom incubation period from spores to germination is different from the environment for growing the mushrooms after the germination period. Therefore, it is preferred to separate incubation rooms from growing rooms to control the environment different for each period.

Specifically, the mushroom incubation period is about 15 days after inoculating the substrate with mushroom spores. The incubation room environment is controlled to be at 23+2° C., 60 to 70% in relative humidity and not to be greater than 1,000 ppm in CO₂ concentration.

The incubation room does not require sunlight, and fluorescent lamps can be installed to implement brightness required for workers. The incubation rooms can be injected with germ-free air for supplying oxygen by means of fans and pipes. Moreover, the incubation rooms can be controlled to be kept at an air pressure slightly higher than the atmospheric pressure not to allow external air (for example, germs) unintentionally to enter the rooms.

Meanwhile, the growing period of mushrooms is approximately 10 days. The environment of the growing rooms is controlled to be at 13+2° C., 90 to 95% in relative humidity and not to be greater than 600 ppm in CO₂ concentration. It is preferred that the light of growing rooms is controlled with fluorescent lamps, and germ-free air is supplied for supplying oxygen by means of fans and pipes, and the rooms are kept at an air pressure slightly higher than the atmospheric pressure not to allow external air (for example, germs) unintentionally to enter the rooms.

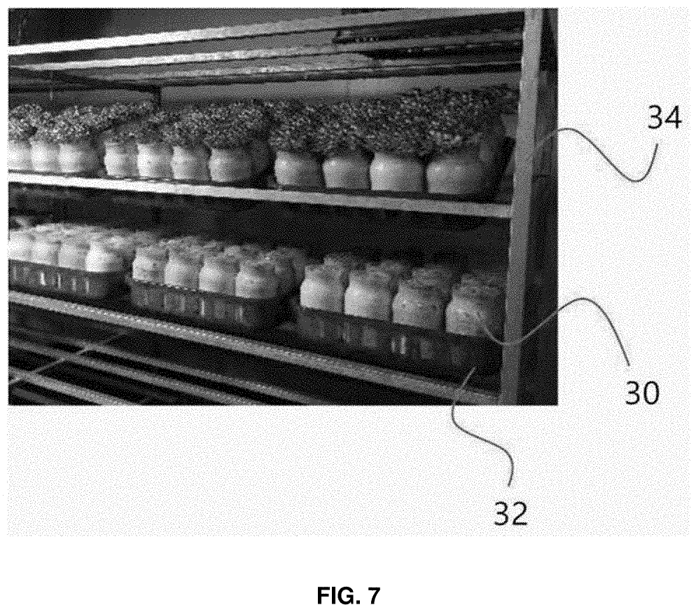

FIG. 7 is a photograph illustrating the state of edible mushrooms grown in cultivation trays in the urban vertical farming system in accordance with an embodiment of the present disclosure.

Referring to FIG. 7, it is an example showing the oyster mushrooms growing in the cultivation trays 30. A plurality of cultivation trays 30 are placed in one cultivation basket 32 to help workers readily lift the cultivation trays 30 to change their position. Each cultivation basket 32 can accept 16 cultivation trays 30. The cultivation trays 30 can be positioned in the cultivation rack 34 while they are in the basket 32.

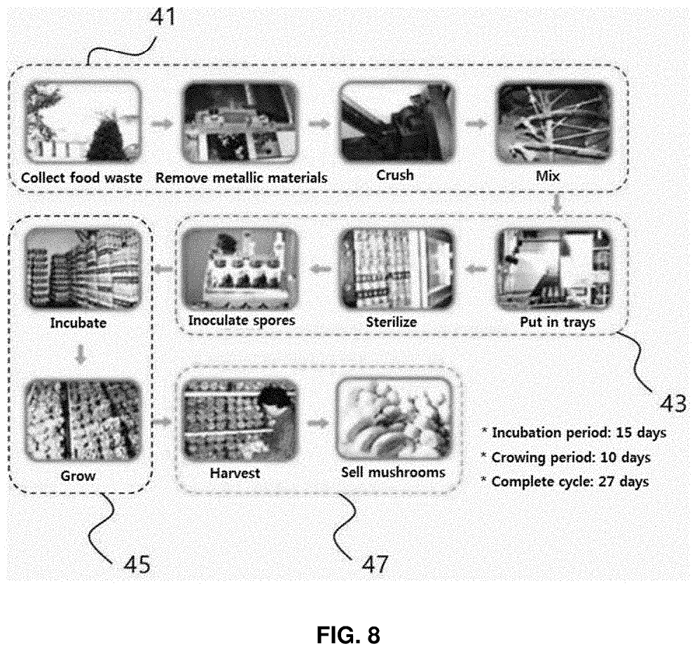

FIG. 8 is a flow illustrating a process of manufacturing a substrate for salt-tolerant edible mushrooms cultivated in the urban vertical farming system linked directly to a shop in accordance with an embodiment of the present disclosure.

Referring to FIG. 8, it is a process of cultivating mushrooms by using crop residues from the vertical farm and food waste collected in urban areas, and includes processes of manufacturing a substrate in operation 41, inoculating the substrate with spores in operation 43, growing mushrooms in operation 45, and harvesting and transporting them in operation 47.

In operation 41 of manufacturing a substrate, crop residues or food waste are inspected to separate metallic matters and then crush the crop residues or food waste to be mixed with woody materials (for example, sawdust) to control substrate moisture levels of about 70% and thus manufacture the substrate. In operation 43 of inoculating the substrate with mushroom spores, the manufactured substrate is placed and sterilized in the cultivation trays, followed by inoculating the substrate with spores of salt-tolerant edible mushrooms, for example, oyster mushrooms.

In operation 45 of growing the mushrooms, the mushroom spores are incubated and grown, and this process can be carried out in the cultivation space 25 of the system in accordance with the present disclosure. The operation 47 of harvesting and transporting the mushrooms is carried out in the process of consumer's buying the mushrooms in the shop space 27 of the system in accordance with the present disclosure.

Although the example described above is for the cultivation space for growing mushrooms in a vertical farming system, the use or structure of the cultivation space can be modified in various types.

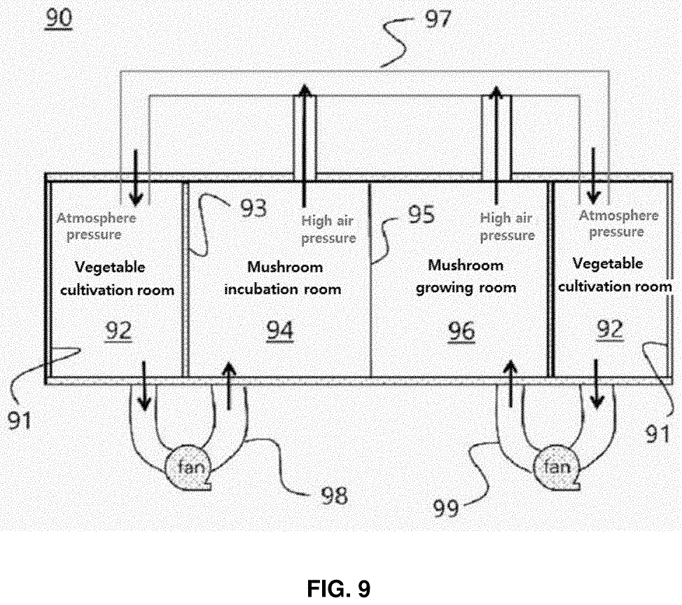

For example, the cultivation space 90 can be divided into vegetable cultivation rooms 92 placed close to external glass walls 91 in a building, and mushroom cultivation rooms 94 and 96 placed on the internal side of the vegetable cultivation rooms 92 as shown in FIG. 9.

This arrangement can contribute to growing green plants, for example, vegetables growing through photosynthesis requiring sunlight in the vegetable cultivation rooms 92, and growing mushrooms not requiring sunlight in the mushroom cultivation rooms 94 and 96.

Although the vegetable cultivation rooms 92 are placed on both sides of the mushroom cultivation rooms 94 and 96, it should be noted that the arrangement of the rooms is not limited thereto, and, for example, the walls 93 can be installed around four sides of the mushroom cultivation rooms 94 and 96, and the vegetable cultivation rooms 92 can be placed on the external side of the walls 93. For photosynthesis, it is preferred that the external glass walls 91 are positioned on one side of the vegetable cultivation rooms 92.

It is preferred to cultivate salt-tolerant edible mushrooms of which the spores are inoculated into the substrate manufactured by recycling crop residues from the urban vertical farm or urban food waste in the mushroom cultivation rooms 94 and 96. Moreover, organic fertilizers manufactured by recycling substrate waste obtained after cultivating mushrooms in the mushroom cultivation rooms 94 and 96 can be used as a substrate for cultivating vegetables in the vegetable cultivation rooms 92, and recycling the residues or waste from mushroom and vegetable cultivation by vertical farming as described above enables more effective operation of the sustainable urban vertical farming system linked directly to a shop.

The walls 93 separating the vegetable cultivation rooms 92 on the external side from the mushroom cultivation rooms 94 and 96 in the central area can be installed to separate the environment for the vegetable cultivation rooms 92 from the environment for the mushroom cultivation rooms 94 and 96 for the purpose of independent control of the environment. Furthermore, lighting fixtures, for example, fluorescent lamps, providing minimum brightness for workers can be installed in the mushroom cultivation rooms 94 and 96.

Meanwhile, the mushroom cultivation rooms 94 and 96 can be divided into an incubation room 94 for incubating mushroom spores after inoculation thereof into the substrate and a growing room 96 for growing young mushrooms to be a marketable size by means of a wall 95. The environment for the incubation room 94 and the growing room 96, respectively, can be controlled independently.

Although the mushroom incubation room 94 is shown placed close to the mushroom growing room 96 on one floor in FIG. 9, it should be noted that the arrangement is not limited thereto. Since a vertical farm can be constructed as a large building with a plurality of floors, various arrangements can be implemented, for example, placing the mushroom incubation room 94 on the second floor but the mushroom growing room 96 on the third floor of the building.

For the cultivation space 90, it is possible independently to control the cultivation environment including temperature, light, humidity and ventilation of the vegetable cultivation rooms 92, the mushroom incubation room 94 and the mushroom growing room 96, respectively, and it can be implemented to install a cooling/heating system, a lighting system, a humidification system and a ventilation system, independently controlled, for the purpose.

While the green plants cultivated in the vegetable cultivation rooms 92 require more carbon dioxide for photosynthesis, the mushroom incubation room 94 and the mushroom growing room 96 can require more oxygen for growing the mushrooms than carbon dioxide required for photosynthesis.

It is preferred to install a pipe system for air circulation between the mushroom cultivation rooms 94 and 96 and the vegetable cultivation rooms 92 in consideration of the different environmental conditions.

For example, as shown in FIG. 9, the pipe system may be installed to include a first pipe system 97 for circulating the air in the mushroom cultivation rooms 94 and 96 into the vegetable cultivation rooms 92, and a second pipe system 98 and 99 for circulating the air in the vegetable cultivation rooms 92 into the mushroom cultivation rooms 94 and 96.

The first pipe system 97 and the second pipe system 98 and 99 can include pipes provided as an air path, and doors for selectively opening or closing the air path for the pipes and/or fans for forced airflow if required.

The doors/fans can be set up to automatically operate when the setting conditions are satisfied, and the setting conditions can include oxygen or carbon dioxide concentrations in the vegetable cultivation rooms 92 and the mushroom cultivation rooms 94 and 96. It can be implemented to install sensors for measuring oxygen and carbon dioxide concentrations in the vegetable cultivation rooms 92 and the mushroom cultivation rooms 94 and 96, and use the concentrations measured by the sensors to control opening and closing the doors of the pipe systems 97, 98 and 99 and operation of the fans.

The pipe system installed as described above can contribute to controlling supply of carbon dioxide which is present more in the mushroom cultivation rooms 94 and 96 to the vegetable cultivation room 92, or oxygen which is present more in the vegetable cultivation rooms 92 to the mushroom incubation room 94 and 96 if required, to optimize growing conditions of the green plants and mushrooms.

Both the first pipe system 97 and the second pipe system 98 and 99 can be installed with fans for forced airflow. However, since the mushroom cultivation rooms 94 and 96 are kept at an air pressure higher than the atmospheric pressure to prevent germs from entering there from the outside in many cases while the vegetable cultivation rooms 92 is kept normally at the atmospheric pressure, the fans for airflow can be omitted in the first pipe system 97 for circulating the air from the mushroom cultivation rooms 94 and 96 into the vegetable cultivation rooms 92.

For example, the first pipe system 97 can be configured as a natural ventilation pipe for circulating the air from the mushroom cultivation rooms 94 and 96 naturally into the vegetable cultivation rooms 92 by means of an atmospheric pressure difference to supply carbon dioxide emitted in the mushroom growth process for vegetable growth.

It is preferred that the second pipe system 98 and 99 are configured as a forced ventilation pipe to force the air in the vegetable cultivation rooms 92 to enter the mushroom cultivation rooms 94 and 96 by operating the fans.

The first pipe system 97 and the second pipe system 98 and 99 can operate simultaneously, and any one of them can operate, or they can operate in sequence or alternately if required.

Although the preferred embodiments of the present disclosure are described in the above, it should be noted that the present disclosure should not be limited by the aforementioned embodiments, can be modified or changed in various types.

For example, while the shop space is hereinabove described to be positioned below the crop cultivation space, the cultivation space can be placed below the shop space, or one cultivation space can be placed below and the other cultivation space above the shop space.

While another example described above is to use two pipe systems between the vegetable cultivation rooms and the mushroom cultivation rooms, it can be implemented to install one pipe system and change the fan rotation direction for forced airflow to control the airflow direction between the vegetable cultivation rooms and the mushroom cultivation rooms.

As described above, it should be noted that the present disclosure can be modified and changed in various types for specific application, and it is natural that the modified and changed embodiments are within the scope of the right of the present disclosure where they encompass the technical idea of the present disclosure disclosed in the following claims.

Description of Numerals in Figures

| | |
|---|---|
| M: crop | 10: vertically-movable rack |
| 11: rack frame 13: horizontal shelf | |
| 20: rack transportation means | |
| 22: vertical fixing frame | |
| 24: rotatable roller | 25: cultivation space |
| 26: transportation control unit | 27: shop space |
| 29: door | 30: cultivation tray |
| 32: basket | 34: cultivation rack |
| 90: cultivation space | 91: external glass wall |
| 92: vegetable cultivation room | 93, 95: wall |
| 94: mushroom incubation room | |
| 96: mushroom growing room | |

What is claimed is:

1. An urban vertical farming system linked directly to a shop in a building, the system comprising:
a crop cultivation space formed in the building;
an environment control unit for controlling the environment of the cultivation space;
a shop space placed close to the cultivation space in the vertical direction;
a vertically-movable rack for placing crops; and
a rack transportation device for moving the vertically-movable rack vertically up and down through an area communicating between the cultivation space and the shop space.

2. The system of claim 1, wherein crops cultivated in the cultivation space comprise salt-tolerant edible mushrooms grown from spores inoculated into a substrate manufactured by recycling crop residues from the cultivation space or urban food waste.

3. The system of claim 2, wherein the cultivation space comprises an incubation room for incubating spores of the salt-tolerant edible mushrooms for germination after inoculation, and a growing room for growing them to be a marketable size after germination; and
the environment control unit comprises an incubation room environment control unit for controlling the environment of the incubation room, and a growing room environment control unit for controlling the environment of the growing room.

4. The system of claim 1, wherein the cultivation space comprises vegetable cultivation rooms for green plants growing through photosynthesis requiring sunlight and mushroom cultivation rooms for cultivating salt-tolerant edible mushrooms of which the spores are inoculated into a substrate manufactured by recycling crop residues from the cultivation space or urban food waste;
the vegetable cultivation rooms are positioned on the internal side of an external glass wall of the building; and
the mushroom cultivation rooms are positioned on the internal side of the vegetable cultivation rooms.

5. The system of claim 4, comprising a pipe system for circulating the air containing much oxygen in the vegetable cultivation rooms into the air containing much carbon dioxide in the mushroom cultivation rooms and vice versa.

6. The system of claim 5, wherein the vegetable cultivation rooms are kept at the atmospheric pressure, and the mushroom cultivation rooms at an air pressure higher than the atmospheric pressure; and
the pipe system comprises a first pipe system for natural ventilation of the air in the mushroom cultivation rooms into the vegetable cultivation rooms by means of an atmospheric pressure difference, and a second pipe system for forced ventilation of the air in the vegetable cultivation rooms into the mushroom cultivation rooms.

7. The system of claim 5, wherein the environment control unit uses measured carbon dioxide concentrations or oxygen concentrations in the vegetable cultivation rooms and the mushroom cultivation rooms to control operation of the pipe system.

8. The system of claim 4, wherein the vegetable cultivation rooms use organic fertilizers by recycling substrate waste after mushroom cultivation in the mushroom cultivation rooms as a substrate for cultivating vegetables; and
the mushroom cultivation rooms use crop residues from cultivating and harvesting vegetables in the vegetable cultivation rooms as a substrate for mushrooms to recycle vegetable and mushroom residues for each other.

9. An urban vertical farming system linked directly to a shop provided with a cultivation space in a building, the system comprising:
vegetable cultivation rooms positioned on the internal side of an external glass wall of the building for cultivating green plants growing through photosynthesis requiring sunlight;
mushroom cultivation rooms positioned on the internal side of the vegetable cultivation rooms for cultivating salt-tolerant edible mushrooms of which the spores are inoculated into a substrate manufactured by recycling crop residues from the cultivation space and urban food waste;
an environment control unit for independently controlling the environment of the vegetable cultivation rooms and the mushroom cultivation rooms, respectively; and
a pipe system for circulating the air containing much oxygen in the vegetable cultivation rooms into the air containing much carbon dioxide in the mushroom cultivation rooms and vice versa.
